(19) United States
(12) Patent Application Publication
(10) Pub. No.: US 2010/0145924 A1
(43) Pub. Date: Jun. 10, 2010

(54) Methods and Devices for Locating Information on a Web Page

(75) Inventors: Michael J. Zabramski, Yorkville, IL (US); Thomas E. Hayosh, Lake Zurich, IL (US); Michael P. Mitchell, Downers Grove, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NOVARRA, INC., Itasca, IL (US)

(21) Appl. No.: 12/328,500

(22) Filed: Dec. 4, 2008

(51) Int. Cl. G06F 17/30; G06F 15/16; G06F 7/06; G06F 17/00

(52) U.S. Cl. 707/709; 709/203; 709/206; 715/234; 707/E17.107

(57) ABSTRACT

Methods and systems locating information on a web page are presented. A client device, such wireless communication device, transmits a request for a web page and a search value. A web proxy receives the request and retrieves the web page from a web server. The web proxy then pre-processes the web page to divide it into web page segments. Alternatively, the request may arrive after the web proxy has pre-processed the web page. The web proxy preferably transmits one or more web page segments containing the search value to the client device, and the client device displays these segments. Furthermore, the client device may transmit the request for the web page and the search value directly to the web server, receive the associated web page from the server, and then locate and display the appropriate web page segment(s).

### BACKGROUND

The public initially became aware of the world-wide web (WWW) around 1993. Since then it has become the predominate form of electronically mediated communication. Today, millions of business, commercial, financial, educational, and entertainment transactions take place every day using WWW (“web”) technology. It is virtually unthinkable for a well-established organization to not have a web site.

Since 1993 there has also been an increase in the viability of wireless communication technologies. Initially used for critical business purposes or by the wealthy, cellular communication has achieved a penetration rate of nearly 100% in many markets. Early wireless data systems supported only very low bitrates, such as about 10 kilobits per second or less. Additionally, early cellular client devices had small screens supporting only text-based output, and very little memory or processing power.

Today, wireless networks can support megabits per second to and from client devices, such as wireless communication devices. Furthermore, these client devices typically contain somewhat larger screens supporting text and graphical output, state of the art processors, and abundant memory. Thus, today's client devices offer an improved web browsing experience over client devices of the past.

However, even the most powerful client devices still have much smaller screens than personal computers (PCs) or laptops. Most modern web sites are designed to be viewed on PC or laptop screens, and thus are not easily suited to a client device's relatively smaller screen. Additionally, even though wireless networks are much faster than they were in the past, wireless network speed still lags wireline network speed. Most modern web sites are also designed for high-speed wireline access, and are therefore content-rich, potentially containing large text files, large graphics files, and extensive scripts. Consequently, wireless access to some web sites can be a slow and painful experience.

Thus, it is desirable to be able to provide a web site experience to client devices that is comparable to the experience provided to PCs and laptops, but takes into consideration the display and network capacity limitations of client devices.

### Overview

In order to provide a high-quality web experience to users of client devices, methods and devices for locating information on a web page are presented. One such aspect involves a packet-switched network, such as the Internet, containing a web proxy placed in a communication path between a client device and a web server. Either responsive to a request from the client device or proactively, the web proxy retrieves a web page from the web server. The web proxy then pre-processes the web page to determine a plurality of web page segments within the web page. Each of these web page segments may relate to a particular component or section of the web page, or a particular grouping of content on the web page.

Preferably, the web proxy transmits at least one web page segment of the plurality to the client device, so that the client device can display the web page segment(s) on its screen. The web proxy may transmit segment(s) that were specifically indicated as desirable by the client device.

For example, the client device may allow a user to specify a uniform resource locator (URL) and a search value, where the URL refers to the web page the user wants to retrieve and the search value specifies content on that web page for which the user has interest. The client device transmits the URL and search value to the web proxy. The web proxy may then search one or more web page segments that contain content representing the search value, and then transmit at least one of these web page segments to the client device.

Since the web page segments are likely to be smaller than the entire web page, each web page segment may more easily fit on the relatively small screen of the client device. In this way, the information on the web page is tailored to both the screen size of the client device and the information sought by the user.

Furthermore, by either only sending the content for which the user has interest, or sending the content that the user is interested in before sending other content, the relatively low bandwidth of wireless technologies is effectively mitigated. The client device can quickly receive and display (e.g., scroll into view) a web page segment containing content representing the search value, while it continues to receive other web page segments. Once the client device finishes receiving web page segments, the client device preferably continues to display the web page segment containing content representing the search value, but allows the user to scroll or pan the client device's display to view other web page segments.

Alternatively, the client device may transmit a request for a URL and a search value directly to a web server. Upon receiving the web page associated with the URL, the client device may pre-process the web page into web page segments and determine that one or more web page segments contain the search value. Accordingly, the client device may then display at least one of these web page segments.

Regardless of how the web page or web page segments are delivered to the client device, the client device may store the URL and search value for later use. Similar to bookmarking a URL on a traditional web browser, this would allow the user of the client device to later access the stored URL and search value so that the user is not required to re-enter this information into the client device.

These and other aspects and advantages will become apparent to those of ordinary skill in the art by reading the following detailed description, with reference where appropriate to the accompanying drawings. Further, it should be understood that the foregoing overview is merely exemplary and is not intended to limit the scope of the invention as claimed.

### BRIEF DESCRIPTION OF THE DRAWINGS

FIG. 1 depicts an example network architecture in accordance with an exemplary embodiment;

FIG. 2 depicts an example web page in accordance with an exemplary embodiment;

FIG. 3 depicts an example call flow in accordance with an exemplary embodiment;

FIG. 4 depicts an example method in accordance with an exemplary embodiment;

FIG. 5 depicts an example flow chart in accordance with an exemplary embodiment;

FIG. 6 is functional diagram of an example web proxy in accordance with an exemplary embodiment; and

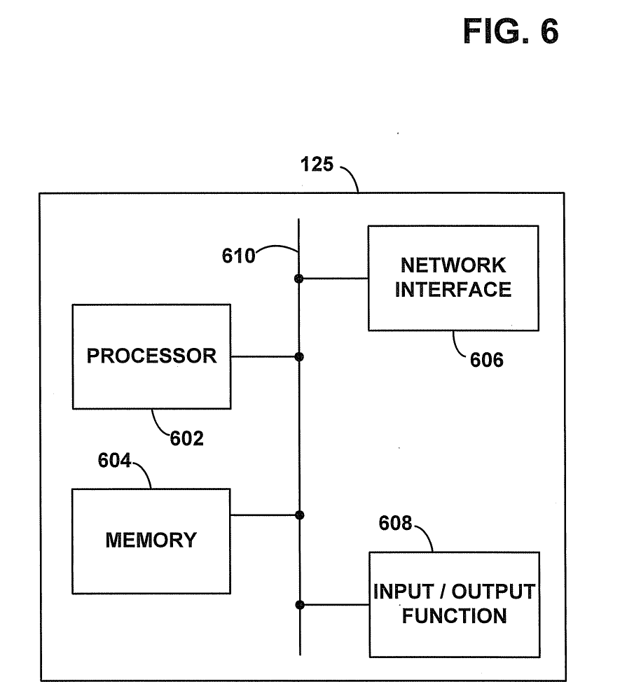

FIG. 7 is functional diagram of an example client device in accordance with an exemplary embodiment.

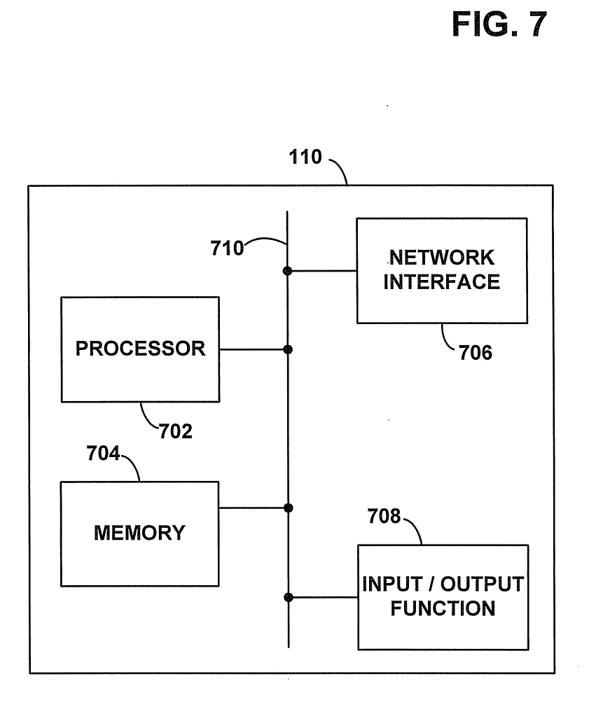

### DESCRIPTION

In accordance with exemplary embodiments, methods and devices for locating information on a web page are presented. Preferably, a web proxy retrieves the web page from a web server and pre-processes the web page into web page segments so that these segments can be selectively delivered to a client device and displayed by the client device.

### I. System Architecture

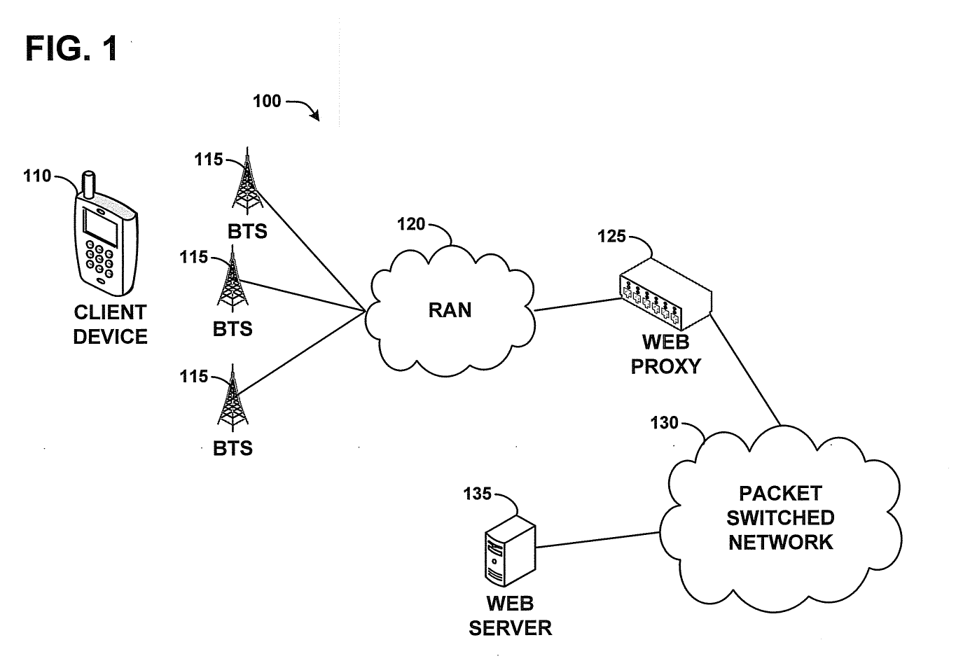

FIG. 1 depicts system 100, in which client device 110 utilizes the wireless resources of one or more base transceiver stations (BTSs) 115. These BTSs are, in turn, communicatively linked to a radio access network (RAN) 120. Via BTSs 115 and RAN 120, client device 110 may access web server 135.

Preferably web proxy 125 is placed in a communication path between client device 110 and web server 135, so that web proxy 125 can intercept and potentially modify web traffic flowing between client device 110 and web server 135. Alternatively, client device 110 may be configured to transmit all web requests to web proxy 125, and web proxy 125 will then retrieve and pre-process web pages from web server 135 on behalf of client device 110, and then transmit these pre-processed web pages to client device 110. Web proxy 125 may be communicatively coupled to packet switched network 130, and may communicate with web server 135 via packet switched network 130.

It should be appreciated that the elements in FIG. 1 are exemplary, and in preferred embodiments more or fewer elements may be included in a system such as system 100, and the elements may be arranged differently or omitted altogether. For example, there may be more than one client device in system 100, and packet switched network 130 may comprise one or more links to the Internet or private networks. Furthermore, these elements may comprise multiple physical or logical devices or components, or may be combined into fewer physical or logical components than are shown in FIG. 1.

The characteristics and functions of each of these elements are described at a high level in the following subsections. However, the descriptions in these subsections are merely introductory and should not be interpreted to limit the characteristics and functions of these elements.

Client device 110 could be a wireless telephone, a wireless personal digital assistant, a wirelessly equipped laptop computer, a wireless router, or another type of mobile or fixed wireless device. Preferably, client device 110 is a subscriber device, which is manipulated by a human user in order to establish circuit-switched or packet-switched voice and/or data calls. However client device 110 could also be an automated device.

Typically, client device 110 is associated with one or more BTSs 115 at a time and uses the wireless coverage areas of these BTSs to communicate with correspondent nodes, such as web servers, web proxies, gaming servers, short message service (SMS) servers, voice over Internet Protocol (VoIP) signaling proxies, VoIP bearer gateways, and other client devices. Client device 110 may also be able to transfer ongoing communication sessions from one BTS 115 to another in a handoff process.

While the discussion here is focused on wireless client devices, wireline devices, and other types of devices, may be used as well. For example, client device 110 could be a set-top box, Internet access appliance, or a remote monitoring device. Client device 110 may even be a remote control for use with an entertainment or gaming system. In other words, it should be understood that the scope and manner of client device 110 is not limited by the text of this specification or by the accompanying drawings.

BTSs 115 radiate energy to define wireless coverage areas. Each wireless coverage area may provide air interface access to client device 110 and any other client device served by the wireless coverage area. A single BTS may define one or more wireless coverage areas. The air interface of these wireless coverage areas may include forward links for transmitting information from a BTS to a client device (in the forward direction) and reverse links for transmitting information from a client device to a BTS (in the reverse direction). Through the forward and reverse links, a BTS and a client device may exchange signaling and bearer traffic. The bearer traffic may include, for example, voice, data, video, or other media. Although FIG. 1 shows three BTSs 115, system 100 may include more or fewer BTSs.

BTSs 115 may operate in accordance to various types of wireless technologies, such as Code Division Multiple Access (CDMA), Worldwide Interoperability for Microwave Access (WIMAX), Universal Mobile Telecommunications System (UMTS), the 3^{rd} Generation Partnership Project (3GPP) Long Term Evolution (LTE), 802.11 (Wifi), or other technologies now known or later developed.

RAN 120 may contain base station controllers (BSCs), radio network controllers (RNCs), mobile switching centers (MSCs), home location registers (HLRs), visitor location registers (VLRs), and various types of Internet Protocol Multimedia Subsystem (IMS) elements to facilitate voice and data services for client devices. While only one RAN is shown in FIG. 1, a wireless service provider may deploy multiple RANs for supplying wireless coverage to a given geographical area, such as a building, city, state, province, or country. While FIG. 1 depicts RAN 120 separately from BTSs 115, in full generality RAN 120 may comprise BTSs 115.

Similar to BTSs 115, RAN 120 may operate in accordance to various types of wireless technologies, such as CDMA, WIMAX, UMTS, 3GPP LTE, 802.11, or other technologies now known or later developed.

Web proxy 125 may be a server device, such as a PC, a blade server, or a network appliance. As such, web proxy 125 may be based on off the shelf hardware and operating systems (e.g., LINUX® or MICROSOFT WINDOWS®), or may be based on proprietary hardware and software.

Preferably, web proxy 125 is configured to retrieve a web page from web server 135, pre-process this web page, and then transmit at least one segment of the web page to a client device, such as client device 110. In order to do so, web proxy 125 may include logic to transmit and receive hypertext transport protocol (HTTP) or HTTP over Transport Layer Security (HTTPS) messages. HTTP is defined in Internet Engineering Task Force (IETF) Request For Comments (RFC) 2616 and is incorporated by reference in its entirety herein. HTTPS is defined in IETF RFC 2818 and is also incorporated by reference in its entirety herein.

Web proxy 125 may also be capable of pre-processing various types of markup languages, including the Hypertext Markup Language (HTML) and the eXtensible Markup Language (XML). HTML is specified by the World Wide Web Consortium (W3C) and version 4.01 of the HTML specification is incorporated by reference in its entirety herein. XML is also specified by the W3C and version 1.1 (second edition) of the XML specification is incorporated by reference in its entirety herein. However, web proxy 125 is preferably arranged to be capable of pre-processing other markup languages as well.

Additionally, web proxy 125 may be capable of pre-processing style information associated with one or more web pages, such as cascading style sheet (CSS) information. Web proxy 125 may also be capable of pre-processing executable code embedded within a web page, such as JavaScript or Asynchronous JavaScript and XML (AJAX). CSS is specified by the World Wide Web Consortium (W3C) and revision 1 of the CSS Level 2 specification is incorporated by reference in its entirety herein. JavaScript is specified by the Mozilla Foundation and version 1.8 of the JavaScript specification is incorporated by reference in its entirety herein. AJAX is a term that refers to a number of web development techniques that facilitate interactive web pages. AJAX techniques require neither JavaScript nor XML, but may use either or both.

In order to accomplish these retrieving, pre-processing, segmentation, and transmission tasks, as well as any other task web proxy 125 may perform, web proxy 125 may include a processor and a memory. The memory may include stored web pages retrieved from web server 135, pre-processed versions of these web pages, information on various client devices that web proxy 125 communicates with, and program instructions executable by the processor to perform the tasks described above.

While web proxy 125 is shown as a single element in FIG. 1, web proxy 125 may be physically or logically subdivided into multiple elements, and these elements may be distributed across one or more RANs and/or one or more packet switched network. For example, in a system with multiple RANs, each RAN may be communicatively linked with a web proxy. Furthermore, web proxy 125 may be comprised within a RAN or within a packet switched network, and may be operated by a wireless service provider or a third party.

Packet switched network 130 may be the Internet, a private IP network, or a data network that does not use the Internet Protocol. Preferably, packet switched network 130 communicatively couples web proxy 125 to web server 135, and possibly to one or more additional web servers as well. In order to do so, packet switched network 130 may be comprised of multiple autonomous IP networks operated by different organizational entities, and packet switched network 130 may span multiple geographical and/or topological locations. Thus, it is possible, for example, that web proxy 125 resides in one country, while web server 135 resides in a different country.

In order to facilitate data communications, packet switched network may contain routers, switches, gateways, and/or firewalls. Furthermore, these elements may be coupled by wireline communication link technologies such as Ethernet, Token Ring, Synchronous Optical Networking (SONET), Asynchronous Transfer Mode (ATM), digital subscriber line (DSL), broadband cable television, or one or more of the various T-carrier systems.

Web server 135 may a server device, such as a PC, a blade server, database, or a network appliance. As such, web server 135 may be based on off the shelf hardware and operating systems (e.g., LINUX® or MICROSOFT WINDOWS®), or may be based on proprietary hardware and software. Web server 135 may comprise several computing devices physically or logically clustered together, or may consist of multiple computing devices spread throughout various locations in packet switched network 130 or accessible from packet switched network 130.

Preferably, web server 135 is configured to store one or more web pages using a variety of formats, such as HTML, XML, CSS, JavaScript, PHP: Hypertext Preprocessor (PHP), and/or Active Server Pages (ASP). These web pages may also contain links to other web pages, as well as links to images or embedded images. Such images may be in various formats, such as Graphics Interchange Format (GIF), Joint Photographic Experts Group (JPEG), Portable Network Graphics (PNG), bitmaps, and so on.

Web server 135 may also comprise or be communicatively coupled with one or more databases. Using scripting routines, such as those found in PHP or ASP based web pages, or using scripting languages such as PERL®, PYTHON®, or RUBY®, web server 135 may retrieve information from at least one of these databases in order to dynamically form a web page that is then transmitted to a client device. In order to facilitate the transmission of static or dynamic web pages, web server 135 may include logic to transmit and receive HTTP or HTTPS.

### II. Exemplary Web Page Structure

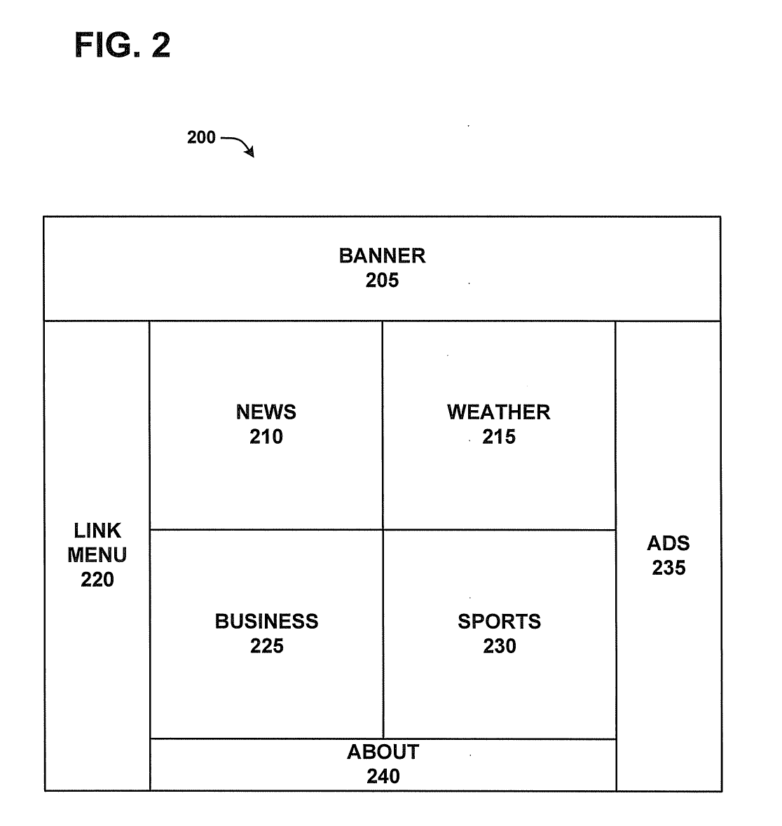

FIG. 2 depicts an exemplary web page layout 200, as it might be displayed on a desktop PC, laptop, cell phone, or another type of wireline or wireless device. Web page layout 200 comprises a number of sections, including banner 205, news 210, weather 215, link menu 220, business 225, sports 230, ads 235, and about 240. Web page layout 200 exemplifies a typical customizable web page that a user can create, modify or use via web portal services such as yahoo.com (YAHOO®), google.com (GOOGLE®), cnn.com (CNN®), and so on. All of these sections may contain articles, hyperlinks, text, video audio, or any other media that is currently or in the future used on web pages.

While web page layout 200 comprises eight sections, such a web page may comprise more or fewer sections. Furthermore, the user may be able to add more sections or remove some of these sections. Additionally, the arrangement of these sections is for purposes of example, and these sections may be arranged differently and sized differently than depicted in FIG. 2.

In web page layout 200, banner 205 section preferably contains a headline, title, or logo of the web portal service. For example, banner 205 may contain a YAHOO® logo, if yahoo.com were the portal serving web page layout 200. News 210, weather 215, business 225, and sports 230 sections preferably contain articles, hyperlinks, text, video or audio pertaining to news, weather, business, and sports, respectively. The content of these sections may be directed to the interests of the user. For instance, if the user has identified themselves as a resident of Chicago, Ill., then news 210 section may contain information about the latest Chicago news, weather 215 section may contain information about current and forecasted Chicago area weather, business 225 section may contain information about Chicago businesses, corporations, and industries, and sports 230 section may contain information about Chicago sports teams.

In web page layout 200, link menu 220 preferably contains one or more hyperlinks to other content on the same web site as the web page, or on other web sites. These hyperlinks may be substantially static, in that they do not change often, or these hyperlinks may be dynamically generated. Ads 235 section preferably contains advertisement information and links to web sites containing third party products or services. Such advertisement information may be served locally from the same web server than the web page is served from, or may be served remotely from, for example, an advertising network's web site. About 240 section preferably contains information about the web portal and its content, such as copyright statements, disclaimers, contact information, and so on.

The sections of web page layout 200 may be formed through the use of HTML tags. Typically, text, audio, video, or other content enclosed by one or more HTML tags will have the displaying instructions associated with those HTML tags applied by any web browser that displays the web page. For example, the <i> tag indicates the beginning of italicized text, and the </i> tag indicates the end of italicized text. Thus, a web browser will typically italicize text enclosed by these tags. (E.g., the snippet of HTML, “The <i>brown fox</i> jumped over the lazy dog,” may appear as “The brown fox jumped over the lazy dog.”)

Other HTML tags may have no discernable impact on the how the web page is displayed by a web browser, and instead provide comments or browser directives. Of course, different web browsers may interpret and display content effected by the same HTML tags differently. Furthermore, these web browsers may apply any relevant style sheet definitions, such as CSS, to HTML tags, this modifying the web browser's interpretation of the tags.

Certain HTML tags may denote sections of a web page. For example, using frames, a web page can be organized into multiple sections, each of which is a logical web page. HTML tags that support the use of frames include the <FRAME> and <FRAMESET> tags. Another method of organizing a web page into multiple sections is through use of <DIV> tags. Using this method, each section of a web page is defined by a named division, and these divisions are delineated on the web page with <DIV> tags.

Other types of HTML tags, such as anchor (<A>) and span (<SPAN>) tags, as well as other currently existing tags or tags defined in the future may also be used to divide a web page into logical sections. Furthermore, HTML form (<FORM>) tags typically define sections of a web page that contain options for user input. For example, the HTML code fragment

<form>
Search:
<input type=“text” name=“search_value”>
</form>

will preferably display the text “Search:” with an adjacent text box for user input. Web pages based on other markup languages, such as XML, may also make use of tags that divide the pages into logical sections.

Thus, for example, web page layout 200 may be defined in HTML by using <DIV> tags to define the banner 205, news 210, weather 215, link menu 220, business 225, sports 230, ads 235, and about 240 sections. Therefore, it would be possible to computationally locate and distinguish each of these sections by parsing the HTML of the web page.

### III. Exemplary Operation

Given that many web pages are divided into sections, and that wireless communication devices typically have small screen sizes that cannot display an entire web page in a readable format, it would be advantageous to be able to selectively deliver one or more of the sections that a user is most interested in to a client device as web page segments.

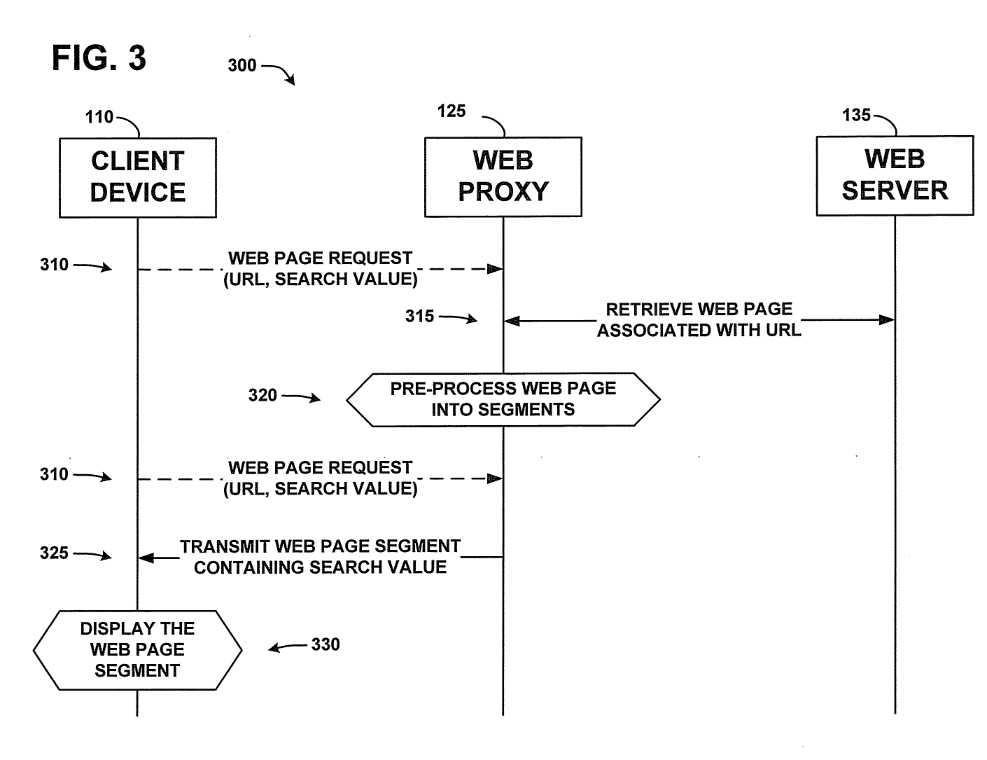

In FIG. 3, call flow 300 depicts such an operation. Call flow 300 includes a series of transactions between client device 110, web proxy 125, and web server 135. However, alternative embodiments may use more or fewer devices.

Preferably, client device 110 contains an interface that allows a user to specify a URL and a search value. A typical web browser allows a user to specify a URL. Once the URL is entered, the typical web browser may retrieve the web page(s) at that URL. Client device 110 may support a web browser that allows a user to specify a URL and a search value. Once the URL and the search value are entered, this web browser, with the assistance of web proxy 125, preferably retrieves the web page and displays (e.g., scroll into view) a segment of the web page containing content representing the search value.

Accordingly, at step 310, client device 110 transmits a web page request, such as an HTTP GET or HTTP POST message, containing the URL and the search value to web proxy 125. Alternatively, step 310 may occur later in call flow 300, such as after step 320.

The search value may be of various forms, including a text string, or some other indication of a search value. For example, the search value might one of the be the text strings “election” or “Chicago Cubs”. Alternatively, the search value might be a descriptive quality, such as an indication of a color, time, or date. Additionally, the search value could represent a login form or a search form. At step 315, web proxy 125 retrieves a web page associated with the specified URL from web server 135. This retrieval process may comprise multiple steps or transactions that are not explicitly shown in FIG. 3.

At step 320, web proxy 125 pre-processes the web page into segments. To do so, web proxy 125 preferably parses the web page's HTML and determines these segments based on sections defined in the web page. For instance, suppose that the web page contains the content shown in web page layout 200, where this content is delineated by <DIV> tags. Then, web proxy 125 may use the <DIV> tags in the web page as delimiters for segments. Thus, banner 205 section would be the basis of one segment, news 210 section would be the basis of another segment, and so on. In forming these web page segments, web proxy 125 may encapsulate the content inside the <DIV> tags of one such section within additional HTML so that the resulting web page segment is effectively a standalone web page.

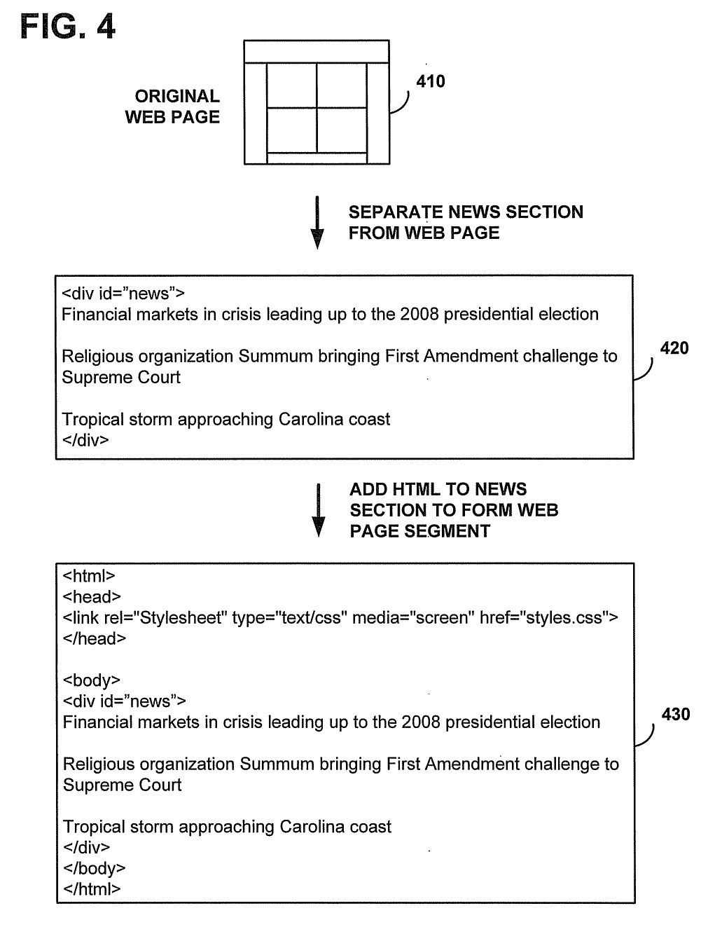

Turning momentarily to FIG. 4, an example of this process is shown. An original web page 410, with a layout similar to that of web page layout 200, contains multiple sections. Preferably, web proxy 125 separates news 420 section from original web page 410. Then, HTML tags are added to news 420 section to form web page segment 430, also preferably by web proxy 125. In the depiction shown in FIG. 4, the added HTML tags include <HTML>, <HEAD>, <LINK>, and <BODY> tags, so that news 420 section is a properly formed HTML document. Additionally, the <LINK> tag references CSS file “styles.css”, which is preferably the CSS file associated with original web page 410. However, more or fewer tags may be added to news 420 section. Furthermore, different tags than the tags listed above may be added to news 420 section.

Alternatively or additionally, web proxy 125 may pre-process original web page 410 to delineate input forms, such as those using the <FORM> tag, as well. Thus, commonly used input forms on a web page, such as a search form or a login form, may be represented as separate web page segments.

Furthermore, this pre-processing may take the characteristics of client device 110 into account. For instance, web proxy 125 may determine one or more characteristics of client device 110 from the information carried in web page request 310 sent by client device 110. These characteristics may be encoded in HTTP headers in web page request 310 or provided using some other mechanism. Example characteristics include screen size, screen resolution, memory size, device model, and network connectivity speed. Web proxy 125 may consider one or more of these characteristics when determining how to pre-process a web page. For example, if client device 110 has a large screen size and ample network connectivity speed, web proxy 125 may pre-process the web page into relatively larger web page segments. On the other hand, if client device 110 has a small screen size or low network connectivity speed, web proxy 125 may pre-process the web page into relatively smaller web page segments.

Additional pre-processing techniques that may be employed by web proxy 125 include dividing a web page into web page segments based on the location of information representing the search value found in the web page. For instance, if a search value is found in a web page, the pre-processing may determine to segment the web page at a markup language tag (e.g., an anchor) found prior to the location of the information representing the search value. This would result in the search value appearing near the beginning of a web page segment, thus allowing the search value to be prominently displayed by the client device.

Turning back to FIG. 3, once step 320 is performed, web proxy 125 may store or cache the web page and one or more pre-processed versions of the web page and/or web page segments in its memory for a period of time. This period of time may be fixed (e.g., 10 minutes), configurable (e.g., between 1 and 10 minutes), dynamic (e.g., depending on how often the web page is accessed by a client device using web proxy 125), or based on other factors. Accordingly, if client device 110 transmits web page request 310 after web proxy 125 retrieves and pre-processes the web page, web proxy 125 may have a stored version of the pre-processed web page and therefore may not need to retrieve the web page once again.

At step 325, web proxy 125 transmits a web page segment containing content representing the search value to client device 110. For example, consider the case of the web page represented by web page layout 200. If the user of client device 110 specifies “news” as the search value that is used in web page request 310, then web proxy 125 preferably searches the pre-processed web page for at least one web page segment that is associated with the search value. In this example, web proxy 125 preferably finds the web page segment containing the news 210 section of the web page, and then transmits this web page segment to client device 110.

At step 330, client device 110 displays the web page segment. This displaying step may include drawing the web page on the screen of client device 110. During and/or after step 330, web proxy 125 may continue transmitting other web page segments from the pre-processed web page to client device 110. Thus, client device 110 may receive these additional web page segments during or after step 330.

While client device 110 preferably displays the web page segment containing content representing the search value, client device 110 may continue loading the rest of the web page segments. Client device 110 may initially focus its display of the web page on the web page segment containing content representing the search value, but the user of client device 110 may subsequently scroll or pan to view these other web page segments as or after they are received. Once again using the example of the web page depicted in web page layout 200, client device 110 may first receive and display news 210 section. Then, perhaps while the user is viewing news 210 section on client device 110, client device 110 receives and displays business 225 section and banner 205 section. Preferably, client device 110 would allow the user to scroll up to view banner 205 and scroll down to view business 225 section.

In an alternate embodiment, at step 325 web proxy 125 may transmit more than just one web page segment containing content representing the search value. For instance, web proxy 125 may transmit all of the web page segments that comprise the pre-processed web page. At step 330, client device 110 preferably displays a web page segment containing content representing the search value, but also receives and displays the other web page segments. Thus, the user of client device 110 can scroll or pan to view these other web page segments as or after they are received.

For instance, suppose that the web page consists of three segments, and that the first segment contains content representing the search value while the second and third segments do not contain content representing the search value. Web proxy 125 may then transmit these three segments to client device 110. Web proxy 125 may label the first segment in some way in order to indicate that it contains content representing the search value. For example, web proxy 125 may place a special tag or attribute in the first segment's markup language document. Alternatively, web proxy 125 may utilize a special HTTP header or metadata when transmitting the segment to client device 110. Regardless of how the first segment is labeled, when client device 110 receives the first segment, it will recognize, from the label, that the first segment contains content representing the search value. Accordingly, client device 110 will preferably display the first segment, even if it is still receiving, or is yet to receive, the second and third segments.

While the search values discussed thus far imply that the user of client device 110 is searching for text within a web page, searches are more general operations and are not limited to textual implementations. A search can directed to a certain type of information or file. For instance, an image search may allow the user to enter a search value, such as a text string, that represents a color. Then, upon receipt of URL and this search value, web proxy 125 may search the web page for items associated with that color. Thus, if the user enters the search value “blue,” web proxy 125 might return a web page segment containing an image file wherein the predominate color is blue, or a web page segment that has a blue background. In another example, the search may be related to shopping or e-commerce, and will return web page segments containing merchandise associated with the search value. For instance, if the user enters a search value of “shoes”, web proxy 125 may return a web page segment representing shoes that can be purchased online. In a similar fashion, searches of audio, video, or other types of files can be facilitated.

Client device 110 may allow the storage of one or more URL and search value pairs, for example as browser bookmarks. Thus, by accessing such a bookmark, a user of client device 110 can rapidly specify the same URL and search value at a later point in time. Client device 110 may allow the same URL to be associated with more than one search value and the same search value to be associated with more than one URL.

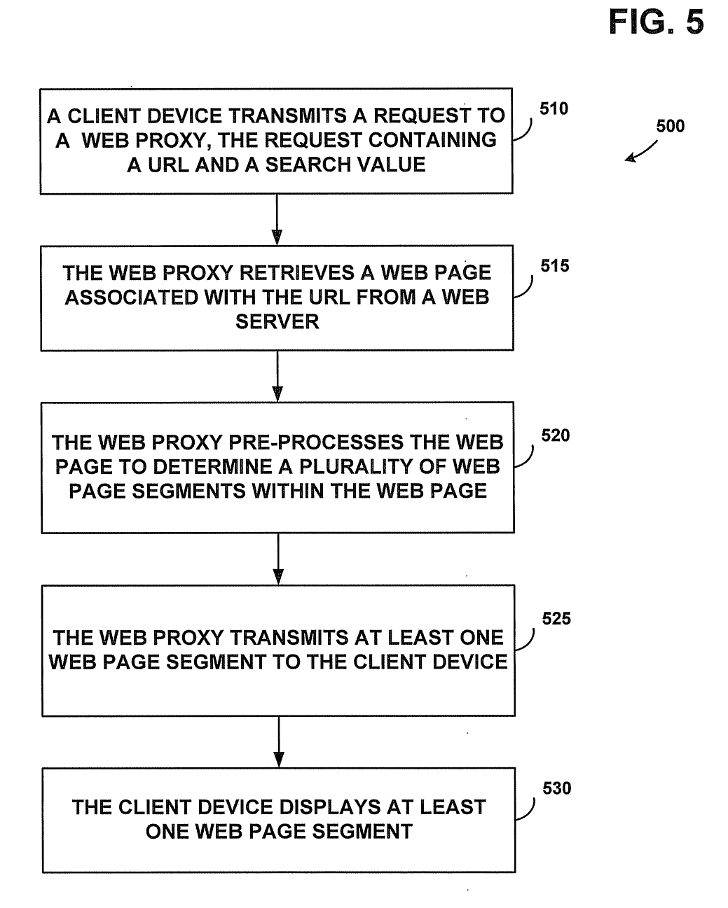

FIG. 5 depicts another example of a preferred mode of operation in flow chart 500. At step 510, a client device, such as client device 110, transmits a request to a web proxy, such as web proxy 125. Preferably, the request contains a URL and a search value. At step 515, the web proxy retrieves a web page associated with the URL from a web server. Step 515 may occur autonomously or in response to step 510.

At step 520, the web proxy pre-processes the web page to determine a plurality of web page segments within the web page. This pre-processing may occur according to the method depicted in FIG. 4, or may occur according to a different process. Regardless of how the web proxy pre-processes the web page, preferably this pre-processing divides the web page into web page segments by using markup language (e.g., HTML) tags as delimiters. For example, HTML tags used as delimiters may be <DIV> tags, <FRAME> tags, <A> tags, <SPAN> tags, <FORM> tags, or any tag associated with the logical structure of the web page or that delineate input forms on the web page.

At step 525, the web proxy transmits at least one web page segment of the plurality to the client device. Note that in some embodiments, step 510 may occur after step 520, and may be combined into step 525. Thus, step 525 may alternatively comprise the steps of (1) the web proxy receiving a URL and a search value from the client device, (2) the web proxy searching the pre-processed web page for the search value, and (3) the web proxy transmitting a segment of the web page containing content representing the search value to the client device.

At step 530, the client device displays at least one web page segment that it received from the web proxy. Preferably, this is a web page segment associated with or containing a search value that the client device originally transmitted to the web proxy. Step 530 may involve the client device receiving the entire web page and jumping to and displaying the at least one web page segment or the client device performing the displaying after receiving the first web page segment of the at least one web page segment and while receiving the remaining segments of the at least one web page segment.

Additionally, the client device may implement a “find next” function. This function preferably allows the user of the client device to search for the next instance of the search value within the currently-displayed web page segments, or across all web page segments received by the client device. For example, assume two web page segments contain content representing the search value. When displaying one of these web page segments, the “find next” function would search for the next instance of content representing the search value, find this next instance in the other web page segment, then display the other web page segment containing this next instance of content.

In an alternative embodiment, not shown in FIG. 5, the client device may transmit a request to a web server, such as web server 135, instead of a web proxy. Preferably, the request contains a URL and a search value. Web server 135 then transmits a web page associated with the URL to the client device. The client device may then pre-process the web page to determine a plurality of web page segments within the web page. This pre-processing may occur according to the exemplary method depicted in FIG. 4, according to other methods discussed above, or according to a different scheme. Regardless of how the client device pre-processes the web page, preferably this pre-processing divides the web page into web page segments by using markup language (e.g., HTML) tags as delimiters.

The client device may then display at least one web page segment that it received from the web proxy. Preferably, the at least one web page segment is associated with or contains the search value that the client device originally transmitted to the web server. This step may involve the client device displaying a first web page segment of the at least one web page segment and while receiving the remaining segments of the at least one web page segment. The “find next” function described above is preferably supported in this embodiment.

Regardless of how the web page or web page segments are delivered to the client device, the client device may store the URL and search value for later use. Similar to bookmarking a URL on a traditional web browser, this would allow the user of the client device to later access the stored URL and search value so that the user it not required to re-enter this information into the client device.

It should be understood that call flow 300 and flow chart 500 are presented for purposes of illustration. These depictions of exemplary operation may contain more or fewer steps, the steps may be arranged in a different order, and the steps may be carried out by different physical or logical entities. Furthermore, call flow 300 and flow chart 500 may be combined, in part or in whole.

### IV. Exemplary Embodiments

The following contains exemplary embodiments of web proxy 125 and client device 110, respectively, illustrating some of the functional components that would likely be found in these elements.

Web proxy 125 could be a server device, or any other type device that retrieves, processes, and delivers web pages on behalf of a client device. Web proxy 125 preferably includes a processor 602, a memory 604, a network interface 606, and an input/output function 608, all of which may be coupled by a system bus 610 or a similar mechanism. Processor 602 preferably includes one or more CPUs, such as one or more general purpose processors and/or one or more dedicated processors (e.g., application specific integrated circuits (ASICs), digital signal processors (DSPs), or network processors, etc.) Memory 604, in turn, may comprise volatile and/or non-volatile memory and can be integrated in whole or in part with processor 602.

Memory 604 preferably holds program instructions executable by processor 602, and data that is manipulated by these instructions to carry out various logic functions described herein. (Alternatively, the logic functions can be defined by hardware, firmware, and/or any combination of hardware, firmware and software.)

Network interface 606 may take the form of a wireline connection, such as an Ethernet, Token Ring, or T-carrier connection. Network interface 406 may also take the form of a wireless connection, such as IEEE 802.11 (Wifi), BLUETOOTH®, or a wide-area wireless connection. However, other forms of physical layer connections and other types of standard or proprietary communication protocols may be used over network interface 606. Furthermore, network interface 606 may comprise multiple physical interfaces.

Input/output function 608 facilitates user interaction with web proxy 125. Input/output function 608 may comprise multiple types of input devices, such as a keyboard, a mouse, a touch screen, and so on. Similarly, input/output function 608 may comprise multiple types of output devices, such as a monitor, printer, or one or more light emitting diodes (LEDs). Additionally or alternatively, web proxy 125 may support remote access from another device, via network interface 606 or via another interface (not shown), such an RS-232 port.

By way of example, memory 604 may comprise program logic executable by processor 602 to retrieve a web page from a web server, then pre-process the web page to determine a plurality of web page segments within the web page. Furthermore, memory 604 may comprise program logic executable by processor 602 to receive, from a client device, a request for the web page (such as a URL) and a search value, then search the web page for content representing the search value. The search value may represent text, a characteristic of a web page, or some other searchable information. The request for the web page and the search value may arrive before or after web proxy 125 pre-processes the web page.

Additionally, memory 604 may comprise program logic executable by processor 602 to transmit at least one web page segment from the plurality of web page segments to the client device, wherein the at least one web page segment contains content representing the search value. Moreover, memory 604 may comprise program logic executable by processor 602 to, after transmitting at least one segment of the web page that contains content representing the search value, transmit at least one at least one web page segment that does not contain content representing the search value.

Client device 110 could be a laptop, cell phone, personal digital assistant (PDA) or another type of wireline or wireless device that can access web pages via a web proxy. Client device 110 preferably includes a processor 702, a memory 704, a network interface 706, and an input/output function 708, all of which may be coupled by a system bus 710 or a similar mechanism. Processor 702 preferably includes one or more CPUs, such as one or more general purpose processors and/or one or more dedicated processors (e.g., application specific integrated circuits (ASICs), or digital signal processors (DSPs), etc.) Memory 704, in turn, may comprise volatile and/or non-volatile memory and can be integrated in whole or in part with processor 702.

Memory 604 preferably holds program instructions executable by processor 702, and data that is manipulated by these instructions to carry out various logic functions described herein. (Alternatively, the logic functions can be defined by hardware, firmware, and/or any combination of hardware, firmware and software.)

Network interface 706 preferable takes the form of a wireless connection, such as IEEE 802.11 (Wifi), BLUETOOTH®, or a wide-area wireless connection. However, network interface 706 may also take the form of a wireline connection. Regardless of the type of connection, various forms of standard or proprietary communication protocols may be used over network interface 706. Furthermore, network interface 706 may comprise multiple physical interfaces.

Input/output function 708 facilitates user interaction with client device 110. Input/output function 708 may comprise multiple types of input devices, such as a keypad, a keyboard, a mouse, a touch screen, and so on. Preferably, input/output function 708 allows a user of client device 110 to specify a URL and a search value. Input/output function 708 may also comprise a video screen for displaying displayed web pages and or web page segments. However input/output function 708 may comprise multiple types of output devices.

By way of example, memory 704 may comprise program logic executable by processor 702 to (1) transmit a request for a web page, the request containing a URL and a search value, receive a web page segment, wherein the web page segment contains the content representing search value, and (2) display and/or otherwise display a representation of the web page segment on the output device. Client device 110 may transmit the request to and receive the web page segment from either a web proxy or a web server associated with the URL. The web page segment may be delivered to client device 110 individually, as part of a group of web page segments from a web page, or in the process of delivering the entire web page. Furthermore, client device 110 may be capable of displaying a representation of the web page segment while receiving additional web page segments that make up the requested web page.

### V. Conclusion

Exemplary embodiments have been described above. Those skilled in the art will understand, however, that changes and modifications may be made to these embodiments without departing from the true scope and spirit of the invention, which is defined by the claims.

What is claimed is:

1. A method for locating information on a web page, wherein a web server, web proxy, and a client device are communicatively linked, the method comprising:
the web proxy retrieving the web page from the web server;
the web proxy pre-processing the web page to determine a plurality of web page segments within the web page;
the web proxy transmitting at least one web page segment from the plurality of web page segments to the client device; and
the client device displaying the at least one web page segment.

2. The method of claim 1, further comprising:
the client device transmitting a request for the web page to the web proxy.

3. The method of claim 2, wherein the web proxy retrieves the web page in response to the client device transmitting the request, and wherein each web page segment of the plurality is smaller than the web page.

4. The method of claim 2, wherein the client device transmits the request after the web proxy pre-processes the web page.

5. The method of claim 1, wherein the at least one web page segment is delimited by hypertext markup language (HTML) tags.

6. The method of claim 1, wherein the at least one web page segment includes an input form.

7. The method of claim 1, wherein the web proxy transmitting at least one web page segment from the plurality of web page segments to the client device comprises:
the web proxy receiving a uniform resource locator and a search value from the client device;
the web proxy searching the web page for content representing the search value; and
the web proxy transmitting a segment of the web page containing content representing the search value to the client device.

8. The method of claim 7, wherein the search value represents a characteristic of an image and the segment of the web page contains an image encompassing the characteristic.

9. The method of claim 7, wherein the search value represents a text string and the segment of the web page contains the text string.

10. The method of claim 7, wherein the search value represents a form chosen from the group consisting of a login form and a search form and the segment of the web page contains the form.

11. The method of claim 1, wherein the client device displaying the at least one web page segment comprises the client device receiving the entire web page and displaying the at least one web page segment.

12. The method of claim 1, wherein the client device displaying the at least one web page segment comprises the client device performing the displaying after receiving a first web page segment and while receiving remaining segments of the web page.

13. A web proxy, configured to retrieve, pre-process, and transmit web pages, the web proxy comprising:
a processor;
a memory;
program logic stored in the memory and executable by the processor to retrieve a web page from a web server;
program logic stored in the memory and executable by the processor to pre-process the web page to determine a plurality of web page segments within the web page;
program logic stored in the memory and executable by the processor to receive, from a client device, a request for the web page and a search value;
program logic stored in the memory and executable by the processor to search the web page for the content representing search value; and
program logic stored in the memory and executable by the processor to transmit at least one web page segment from the plurality of web page segments to the client device, wherein the at least one web page segment contains content representing the search value.

14. The web proxy of claim 13, wherein the request for the web page comprises a uniform resource locator (URL), and wherein the web page is associated with the URL.

15. The web proxy of claim 13, wherein the search value represents a characteristic of an image and the segment of the web page contains an image encompassing the characteristic.

16. The web proxy of claim 13, wherein the request for the web page and the search value arrives before the web proxy retrieves the web page.

17. The web proxy of claim 13, wherein the request for the web page and the search value arrives after the web proxy pre-processes the web page.

18. The web proxy of claim 13, further comprising:
program logic stored in the memory and executable by the processor to, after transmitting the at least one segment of the web page that contains the search value, transmit at least one web page segment that does not contain the search value.

19. A client device for displaying information representing a first web page segment, the client device comprising:
an output device for displaying a representation of the first web page segment;
an input device for specifying a uniform resource locator (URL) and a search value;
a processor;
a memory;
program logic stored in the memory and executable by the processor to transmit a request for a web page, the request containing the URL and the search value;
program logic stored in the memory and executable by the processor to receive the web page, wherein the web page contains the first web page segment, and wherein the first web page segment contains content representing the search value; and
program logic stored in the memory and executable by the processor to display a representation of the first web page segment on the output device.

20. The client device of claim 19, wherein transmitting the request comprises transmitting the request to a web proxy, and wherein receiving the first web page segment comprises receiving the first web page segment from the web proxy.

21. The client device of claim 20, wherein the output device displays the representation of the first web page segment while the client device is receiving further web page segments of the plurality.

22. The client device of claim 21, further comprising:
program logic stored in the memory and executable by the processor to allow a user of the client device to request that the client device search for an additional instance of the search value within the plurality of web page segments; and
program logic stored in the memory and executable by the processor to display a representation of a second web page segment on the output device, wherein the second web page segment contains content representing the search value.

23. The client device of claim 22, further comprising:
program logic stored in the memory and executable by the processor to search the first web page segment for the additional instance of the search value;
program logic stored in the memory and executable by the processor to, in response to failing to locate the additional instance of the search value on the first web page segment, request the second web page segment from the web proxy, wherein the second web page segment contains the additional instance of the search value; and
program logic stored in the memory and executable by the processor to receive the second web page segment from the web proxy.

24. The client device of claim 19, wherein the program logic stored in the memory and executable by the processor to receive the web page comprises:
program logic stored in the memory and executable by the processor to pre-process the web page to determine the first web page segment contained therein.

25. The client device of claim 19, further comprising:
program logic stored in the memory and executable by the processor to associate the URL and search value with one another;
program logic stored in the memory and executable by the processor to store the associated URL and search value in the memory; and
program logic program logic stored in the memory and executable by the processor to retrieve the associated URL and search value from the memory.

26. The method of claim 19, wherein program logic stored in the memory and executable by the processor to display a representation of the first web page segment on the output device comprises:
program logic stored in the memory and executable by the processor to scroll the first web page segment into view on the output device.
